(19) United States
(12) Patent Application Publication
(10) Pub. No.: US 2020/0208007 A1
(43) Pub. Date: Jul. 2, 2020

(54) STIMULI-RESPONSIVE COLOR-CHANGING FUNCTIONAL COATING, PREPARATION METHOD AND APPLICATION THEREOF

(71) Applicants: Shaanxi University of Technology, Shaanxi (CN); University of Akron, Akron, OH (US)

(72) Inventors: Haichang Zhang, Shaanxi (CN); Qixin Zhou, Akron, OH (US); Zhifeng Deng, Shaanxi (CN); Weixiu Zeng, Akron, OH (US)

(21) Appl. No.: 16/259,125

(22) Filed: Jan. 28, 2019

(30) Foreign Application Priority Data
Dec. 28, 2018 (CN) 201811623308.6

(51) Int. Cl. C09D 163/00; C09D 5/29; C09D 5/02

(52) U.S. Cl. CPC C09D 163/00; C08K 5/1535; C09D 5/028; C09D 5/29

(57) ABSTRACT

A stimuli-responsive color-changing functional coating is prepared from the following raw materials: an epoxy resin, a furanone pigment, an amine curing agent, and a solvent. The furanone pigment is an organic conjugated conductive molecule. The amine curing agent reacts with the furanone pigment to form a cross-linked molecule containing a hydrogen bond that can exhibit excellent electron transition behaviors. Moreover, as the cross-linked molecule is unstable, it may give rise to electron transitions with different properties under different stimulus conditions, imparting a color-changing property to the coating that allows the coating to have different colors in response to different environmental stimuli. Experimental results show that the stimuli-responsive color-changing functional coating in the present invention has thermochromic, ultraviolet-photochromic and strongly acidochromic properties, and is responsive to diverse color-changing stimulus conditions with a wide color-changing range.

### CROSS-REFERENCE TO RELATED APPLICATION

This application claims priority to Chinese application number 201811623308.6, filed on Dec. 28, 2018. The above-mentioned patent application is incorporated herein by reference in its entirety.

### TECHNICAL FIELD

The present invention belongs to the technical field of coatings and their applications, and more particularly, relates to a stimuli-responsive color-changing functional coating and associated methods and applications.

### BACKGROUND

Stimuli-responsive color-changing materials are materials that may have reversible or irreversible color changes in response to the stimuli of the changing external environment. Stimuli-response conditions to these materials may be subjected typically from the changes of temperature, light intensity, pH value, electric field intensity, and magnetic field intensity in the environment where the materials are present, leading to respective thermochromism, photochromism, halochromism and magnetochromism. The functionalities of a material can be increased by imparting a color changing function to the material. For example, the use of a color changing material in a coating allows the change of the environment to be reflected by the change in the color of the coating, etc.

Epoxy resin coatings, which are excellent in comprehensive performance with good corrosion resistance and high adhesion to metals, have been extensively used in flooring, automobiles, food packaging, and etc. Currently, some epoxy resin coatings have been prepared to be capable of changing color in response to stimuli. For example, the Chinese Patent Application No. CN102372993A discloses that a color-changing epoxy resin coating is prepared from inorganic fillers such as zinc oxide by physical blending, where the color of the coating can only change along with the change of temperature within a temperature range of 24−100° C. The Chinese Patent Application No. CN102675580A discloses that a purely electrochromic epoxy resin material is prepared by introducing structural units, namely a triphenylamine group and derivatives thereof, into the main chain of the epoxy resin by chemical synthesis. The Chinese Patent Application No. CN104964543A discloses that a photochromic epoxy resin coating is prepared from an inorganic pigment vanadium pentoxide by physical blending, where the coating may change color only when exposed to ultraviolet light with a 365 nm wavelength.

The above color-changing epoxy resin coatings that are obtained by adding inorganic substances or by changing the main chain structure of the epoxy resin can only change color under a single stimulus condition (temperature, electric field or ultraviolet light). The single-color change stimulus cannot meet the requirements of the modern society on multifunctional color-changing coatings, which is a disadvantage.

Therefore, it would be desirable to provide a stimuli-responsive color-changing functional coating that can change color with temperature, under to the ultraviolet light exposure, or with the change of the pH value of the environment. It would also be desirable to provide a preparation method and an application of the stimuli-responsive color-changing functional coating that may be simple and practicable, to address the above-described and other deficiencies in this art field.

### SUMMARY

To achieve the above purpose, the present invention provides the following technical solutions, in one embodiment: The present invention provides a stimuli-responsive color-changing functional coating, prepared from the following raw materials: an epoxy resin, a furanone pigment, an amine curing agent, and a solvent.

In one aspect, the furanone pigment is selected from furofuran and/or benzodifuranone.

In another aspect, the furanone pigment is selected from one or more of 1,8-benzodifuranone, 1,5-benzodifuranone, and furofuran.

In a further aspect, the amine curing agent is selected from a primary amine curing agent and/or a secondary amine curing agent; and the solvent is a non-activated thinner.

In yet another aspect, the non-activated thinner is selected from one or more of acetone, toluene, xylene, and N,N-dimethylformamide.

In one aspect, the amount of the epoxy resin is based on the quantity of epoxy groups, and the amount of the amine curing agent is based on the quantity of amine hydrogen; a molar ratio of the epoxy resin to the amine curing agent is (0.5-2.0):1; the mass of the furanone pigment is 1.5-2.5% of the total mass of the epoxy resin, the furanone pigment and the amine curing agent; and the mass of the solvent is 15-30% of the total mass of the stimuli-responsive color-changing functional coating.

In another embodiment of the invention, a preparation method of the stimuli-responsive color-changing functional coating of the above technical solution is provided and includes the following steps: (1) mixing a furanone pigment with a solvent, and then removing bubbles to obtain a furanone pigment solution; (2) mixing the furanone pigment solution obtained in the step (1) with an epoxy resin to obtain a mixed feed solution; (3) mixing the mixed feed solution obtained in the step (2) with an amine curing agent, and then removing bubbles to obtain the stimuli-responsive color-changing functional coating.

In a further embodiment, the present invention provides an application of the stimuli-responsive color-changing functional coating of the above technical solution in responses to environmental stimuli.

In one aspect, the application includes: applying the stimuli-responsive color-changing functional coating over a substrate, and after the coating is cured, exerting an environmental stimulus thereto, allowing an environmental change to be reflected by a change in color, wherein the environmental stimulus comprises a temperature, ultraviolet light or a pH value.

In another aspect, the invention can be used in a smart sensor material, an anti-counterfeiting device or crop growth that is susceptible to a temperature, responsive to ultraviolet light or responsive to a strongly acidic condition.

The stimuli-responsive color-changing functional coating of the present invention includes an epoxy resin, a furanone pigment, an amine curing agent, and a solvent. In the present invention, the epoxy resin, which serves as the host material of the coating and the amine curing agent, enables the coating to have a curable film-forming characteristic constitute the base of the stimuli-responsive color-changing functional coating. The furanone pigment is an organic conjugated conductive molecule. The amine curing agent which contains an NH group and the furanone pigment which contains a C═O group can react to form a cross-linked molecule containing a hydrogen bond that is structurally like a cross-linked conjugated substance. The cross-linked molecule can exhibit excellent electron transition behaviors with different properties at different environmental stimuli. Moreover, as the cross-linked molecule is unstable, it may give rise to electron transitions with different properties under different stimulus conditions, imparting a color-changing property to the coating that allows the coating to have different colors at different environmental stimuli.

As shown by experimental results, with the temperature increasing, the color of the stimuli-responsive color-changing functional coating in the present invention may change from dark blue to brownish yellow in a temperature range of 80-120° C. (heating for more than 1.5 hours). When exposed to ultraviolet irradiation (340 nm, 45° C., an irradiation intensity of 0.68 W/m², and irradiation lasting for more than 4 hours), the color of the coating may change from dark blue to brownish yellow over the time of irradiation. Under a strongly acidic condition (a pH value of less than or equal to 1.05, and the immersion time of more than 3 hours), the color of the coating may change from dark blue to brownish yellow over the time of immersion. The stimuli-responsive color-changing functional coating provided in the present invention is responsive to diverse color-changing stimulus conditions with a wide color-changing range.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Various additional features and advantages of the invention will become more apparent to those of ordinary skill in the art upon review of the following detailed description of one or more illustrative embodiments taken in conjunction with the accompanying drawings. The accompanying drawings, which are incorporated in and constitute a part of this specification, illustrate one or more embodiments of the invention and, together with the general description given above and the detailed description given below, explain the one or more embodiments of the invention.

FIG. 1A is a color change diagram showing the stimuli-responsive color-changing functional coating film of a first embodiment of the invention in response to different environmental temperatures, where a shows images of film colors at different temperatures.

FIG. 1B is a graphical plot of an ultraviolet/visible spectrum of the coating film of FIG. 1A.

FIG. 1C is a graphical plot of several parameter values of the coating film of FIG. 1A.

FIG. 2A is a color change diagram showing the stimuli-responsive color-changing functional coating film of the first embodiment in response to ultraviolet irradiation under different amounts of time.

FIG. 2B is a graphical plot of an ultraviolet/visible spectrum of the coating film of FIG. 2A.

FIG. 2C is a graphical plot of several parameter values of the coating film of FIG. 2A.

FIG. 3A is a color change diagram showing the stimuli-responsive color-changing functional coating film of the first embodiment in response to a strongly acidic solution with different immersion time periods, under the condition of a pH value of 1.05.

FIG. 3B is a color change diagram showing the stimuli-responsive color-changing functional coating film of the first embodiment before and after being immersed in solutions with different pH values for 48 hours.

FIG. 3C is a graphical plot of an ultraviolet/visible spectrum of the coating film of FIG. 3A.

FIG. 3D is a graphical plot showing color difference of the coating film of FIG. 3A.

### DETAILED DESCRIPTION

The following clearly and completely describes the technical solutions in the embodiments of the present invention with reference to the accompanying drawings in the embodiments of the present invention. To make objectives, features, and advantages of the present invention clearer, the following describes embodiments of the present invention in more detail with reference to accompanying drawings and specific implementations.

The present invention provides, in some embodiments, a stimuli-responsive color-changing functional coating that is prepared from the following raw materials: an epoxy resin, a furanone pigment, an amine curing agent, and a solvent.

In the present invention, all components are commercially available products which are well known to those skilled in the field unless otherwise stated.

In one embodiment, the furanone pigment is preferably selected from furofuran and/or benzodifuranone. In the present invention, the furanone pigment is preferably selected from one or more of 1,8-benzodifuranone, 1,5-benzodifuranone, and furofuran. In the present invention, the structural formula of 1,8-benzodifuranone (1,8-BDF) is shown in formula (1), while the structural formula of 1,5-benzodifuranone (1,5-BDF) is shown in formula (2), and the structural formula of furofuran (iBFFB) is shown in formula (3). In the present invention, the mass of the furanone pigment is preferably 1.5-2.5% of the total mass of the epoxy resin, the furanone pigment and the amine curing agent. In the present invention, the furanone pigment is an organic conjugated conductive molecule, and the amine curing agent can react with the furanone pigment to form a similar cross-linked conjugated substance containing a hydrogen bond. This substance can exhibit excellent electron transition behaviors at different environmental stimuli, and the coating can be imparted with a color-changing property by the electron transitions.

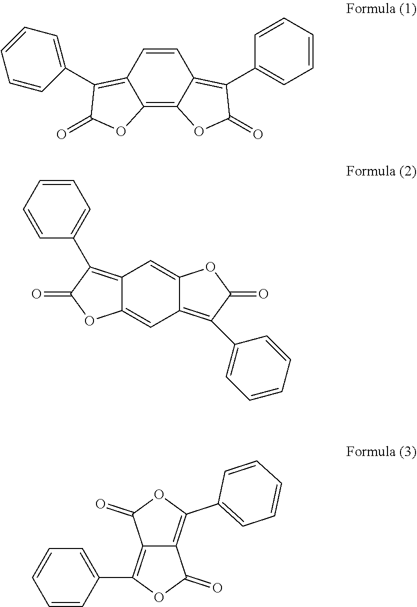 [SMILES: O=C1Oc2c3c(ccc2=C1c1ccccc1)=C(c1ccccc1)C(=O)O3 ; O=C1Oc2cc3c(cc2=C1c1ccccc1)OC(=O)C=3c1ccccc1 ; O=C1OC(c2ccccc2)=C2C(=O)OC(c3ccccc3)=C12]

With no specific limitation on the source of the furanone pigment in the present invention, the furanone pigment can be prepared by any method well known to those skilled in the art. In the present invention, the 1,8-benzodifuranone, 1,5-benzodifuranone and furofuran are preferably prepared with reference to the method in the paper “Haichang Zhang, Bernd Tieke, Conjugated polymers containing benzo- and naphthodione units in the main chain, 2014, 5, 6391; [2]Y. S. Rao, Recent advances in the chemistry of unsaturated lactones, 1976, 76, 5, 625-694.”

In one embodiment, the solvent is preferably a non-activated thinner. In the present invention, the non-activated thinner is preferably selected from one or more of acetone, toluene, xylene, and N,N-dimethylformamide. In the present invention, the mass of the solvent is preferably 15-30%, more preferably 18-28%, and most preferably 25%, of the total mass of the stimuli-responsive color-changing functional coating. In the present invention, the solvent can reduce the viscosity of the coating, so that the coating has certain fluidity and is convenient to apply.

With no specific limitation on the epoxy resin in the present invention, any epoxy resin well known to those skilled in the art can be used. In the present invention, the epoxy resin is preferably a liquid epoxy resin. In the present invention, the epoxy resin is preferably bisphenol A epoxy resin, more preferably epoxy resin 828, epoxy resin 6101 or epoxy resin 631.

In some embodiments, the amine curing agent is preferably selected from a primary amine curing agent and/or a secondary amine curing agent, more preferably polyamide curing agent 3164, polyamide curing agent 650 or polyamide curing agent 3388. In the present invention, the amine curing agent plays a role in accelerating curing and film-forming of the coating.

In the present invention, the amount of the epoxy resin is based on the quantity of epoxy groups, and the amount of the amine curing agent is based on the quantity of amine hydrogen; and a molar ratio of the epoxy resin to the amine curing agent is (0.5-2.0):1. Specifically, in the present invention, a ratio of the amount of the epoxy resin to the amount of the amine curing agent is calculated according to the epoxy equivalent values and the active hydrogen equivalent values in the Certificates Of Authenticity (COAs) of the respective raw materials, where an epoxy equivalent value represents the mass of the epoxy resin containing 1 mol of epoxy groups, and an active hydrogen equivalent value represents the mass of the amine curing agent containing 1 mol of active hydrogen. Accordingly, the actual amount of the epoxy resin and that of the amine curing agent are preferably in accordance with the ratio of formula (I).

$$\frac{Actual amount of epoxy resin}{Epoxy equivalent value} \text{:} \frac{Actual amount of amine curing agent }{Amine hydrogene quivalent value} = ( 0.5 - 2.0 ) \text{:} 1 \qquad Formula ( I )$$

In the present invention, the epoxy resin and the amine curing agent together constitute the base of the stimuli-responsive color-changing functional coating.

In the present invention, the furanone pigment is an organic conjugated conductive molecule. The amine curing agent which contains an NH group and the furanone pigment which contains a C═O group can react to form a substance containing a hydrogen bond (N—H . . . O═C), as shown below:

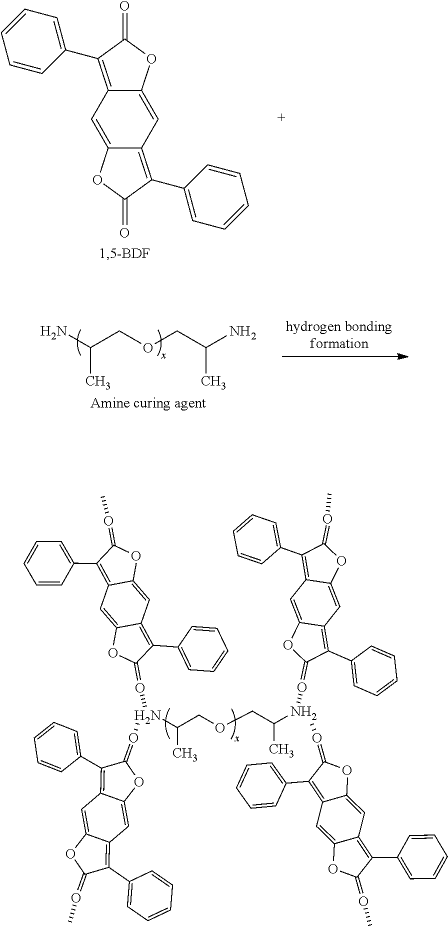

The substance containing the hydrogen bond (N—H . . . O═C) can exhibit excellent electron transition behaviors with different properties at different environmental stimuli. Moreover, as the cross-linked molecule is unstable, it may give rise to electron transitions with different properties under different stimulus conditions, imparting a color-changing property to the coating, thus allowing the coating to have different colors at different environmental stimuli.

The present invention further provides a preparation method of the stimuli-responsive color-changing functional coating according to the above technical solution. The preparation method includes the following steps: (1) mix a furanone pigment with a solvent, and then remove bubbles to obtain a furanone pigment solution; (2) mix the furanone pigment solution obtained in the step (1) with an epoxy resin to obtain a mixed feed solution; (3) mix the mixed feed solution obtained in the step (2) with an amine curing agent, and then remove bubbles to obtain the stimuli-responsive color-changing functional coating.

In the present invention, the amount of each raw material used for preparation in the preparation method is consistent with the amount of each raw material in the foregoing technical solution of the stimuli-responsive color-changing functional coating, which will not be redundantly described herein.

According to the present invention, a furanone pigment is mixed with a solvent, and then bubbles are removed to obtain a furanone pigment solution. With no specific limitation on the mixing manner in the present invention, any mixing manner well known to those skilled in the art can be adopted. In the present invention, the mixing manner is preferably stirring. In the present invention, the stirring is preferably magnetic stirring. In the present invention, the revolving speed of the magnetic stirring is preferably 800-1100 r/min, and more preferably 800-1000 r/min. The time of the magnetic stirring is preferably 5-15 min, and more preferably 5-10 min. According to the present invention, by mixing, it can be guaranteed that the furanone pigment is uniformly dispersed in the solvent. With no specific limitation on the method of removing bubbles in the present invention, any method of removing bubbles well known to those skilled in the art can be adopted. In the present invention, the method of removing bubbles is preferably ultrasonic. In the present invention, the ultrasonic frequency is preferably 35-45 kHz, more preferably 37-43 kHz, and most preferably 40 kHz. The ultrasonic time is preferably 25-40 min, and more preferably 25-35 min.

According to the present invention, after the furanone pigment solution is obtained, the furanone pigment solution is mixed with an epoxy resin to obtain a mixed feed solution. With no specific limitation on the mixing manner in the present invention, any mixing manner well known to those skilled in the art can be adopted. In the present invention, the mixing manner is preferably stirring. In the present invention, the stirring is preferably magnetic stirring or mechanical stirring. In the present invention, the revolving speed of the magnetic stirring is preferably 800-1100 r/min, and more preferably 800-1000 r/min. The time of the magnetic stirring is preferably 10-20 min, and more preferably 10-15 min. In the present invention, the revolving speed of the mechanical stirring is preferably 800-1100 r/min, and more preferably 800-1000 r/min. The time of the mechanical stirring is preferably 10-20 min, and more preferably 10-15 min.

According to the present invention, after the mixed feed solution is obtained, the mixed feed solution is mixed with an amine curing agent, and then bubbles are removed to obtain the stimuli-responsive color-changing functional coating. With no specific limitation on the mixing manner in the present invention, any mixing manner well known to those skilled in the art can be adopted. In the present invention, the mixing manner is preferably stirring. In the present invention, the stirring is preferably magnetic stirring or mechanical stirring. In the present invention, the revolving speed of the magnetic stirring is preferably 800-1100 r/min, and more preferably 800-1000 r/min. The time of the magnetic stirring is preferably 10-20 min, and more preferably 10-15 min. In the present invention, the revolving speed of the mechanical stirring is preferably 350-450 r/min, and more preferably 350-450 r/min. The time of the mechanical stirring is preferably 10-20 min, and more preferably 10-15 min. According to the present invention, by mixing, it can be guaranteed that the furanone pigment is uniformly dispersed in the solvent. With no specific limitation on the method of removing bubbles in the present invention, any method of removing bubbles well known to those skilled in the art can be adopted. In the present invention, the method of removing bubbles is preferably ultrasonic. In the present invention, the ultrasonic frequency is preferably 35-45 kHz, more preferably 37-43 kHz, and most preferably 40 kHz. The ultrasonic time is preferably 5-15 min, and more preferably 5-10 min.

With no specific limitation on the way of using the stimuli-responsive color-changing functional coating in the present invention, any way of using the stimuli-responsive color-changing functional coating that is well known to those skilled in the art can be adopted. In the present invention, the way of using the coating is preferably curing for film forming. In the present invention, the curing for film forming is preferably carried out away from light. The temperature of the curing for film forming is preferably 15-25° C. The time of the curing for film forming is preferably 7 days.

The present invention further provides an application of the stimuli-responsive color-changing functional coating according to the above technical solution in the response to environmental stimuli. In the present invention, the application preferably includes: apply the stimuli-responsive color-changing functional coating over a substrate, and after the coating is cured, exert an environmental stimulus thereto, allowing an environmental change to be reflected by a change in color. In the present invention, the environmental stimulus includes a temperature, ultraviolet light or a pH value. In the present invention, the application refers to an application in a smart sensor material, an anti-counterfeiting device or crop growth that is susceptible to a temperature, responsive to ultraviolet light or responsive to a strongly acidic condition.

To further illustrate the present invention, the stimuli-responsive color-changing functional coating, the preparation method and the application thereof provided in the present invention will be described in detail below in combination with embodiments, which, however, may not be understood as limitations to the protection scope of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

### Embodiment 1

Firstly, 1.7 g of 1,5-benzodifuranone and 25 g of acetone were magnetically stirred at a revolving speed of 900 r/min for 5 minutes, and then subjected to ultrasonic treatment for 30 minutes at a frequency of 40 kHz to obtain a 1,5-benzodifuranone pigment solution. Then, the obtained 1,5-benzodifuranone pigment solution and 31.1 g of epoxy resin 828 were magnetically stirred at 900 r/min for 10 minutes to obtain a mixed feed solution. Finally, the mixed feed solution and 42.2 g of polyamide curing agent 3164 were magnetically stirred at 900 r/min for 10 minutes, and then subjected to ultrasonic treatment for 5 minutes at 40 kHz to obtain the stimuli-responsive color-changing functional liquid coating.

### Embodiment 2

Firstly, 1.7 g of 1,8-benzodifuranone and 25 g of acetone were magnetically stirred at a revolving speed of 900 r/min for 5 minutes, and then subjected to ultrasonic treatment for 30 minutes at a frequency of 40 kHz to obtain a 1,8-benzodifuranone pigment solution. Then, the obtained 1,8-benzodifuranone pigment solution and 31.1 g of epoxy resin 828 were magnetically stirred at 900 r/min for 10 minutes to obtain a mixed feed solution. Finally, the mixed feed solution and 42.2 g of polyamide curing agent 3164 were magnetically stirred at 900 r/min for 10 minutes, and then subjected to ultrasonic treatment for 5 minutes at 40 kHz to obtain the stimuli-responsive color-changing functional liquid coating.

### Embodiment 3

Firstly, 1.7 g of furofuran and 25 g of acetone were magnetically stirred at a revolving speed of 900 r/min for 5 minutes, and then subjected to ultrasonic treatment for 30 minutes at a frequency of 40 kHz to obtain a furofuran pigment solution. Then, the obtained furofuran pigment solution and 31.1 g of epoxy resin 828 were magnetically stirred at 900 r/min for 10 minutes to obtain a mixed feed solution. Finally, the mixed feed solution and 42.2 g of polyamide curing agent 3164 were magnetically stirred at 900 r/min for 10 minutes, and then subjected to ultrasonic treatment for 5 minutes at 40 kHz to obtain the stimuli-responsive color-changing functional liquid coating.

### Embodiment 4

Firstly, 1.7 g of 1,5-benzodifuranone and 25 g of acetone were magnetically stirred at a revolving speed of 900 r/min for 5 minutes, and then subjected to ultrasonic treatment for 30 minutes at a frequency of 40 kHz to obtain a 1,5-benzodifuranone pigment solution. Then, the obtained 1,5-benzodifuranone pigment solution and 31.1 g of epoxy resin 6101 were magnetically stirred at 900 r/min for 10 minutes to obtain a mixed feed solution. Finally, the mixed feed solution and 42.2 g of polyamide curing agent 650 were magnetically stirred at 900 r/min for 10 minutes, and then subjected to ultrasonic treatment for 5 minutes at 40 kHz to obtain the stimuli-responsive color-changing functional liquid coating.

### Embodiment 5

Firstly, 1.7 g of 1,5-benzodifuranone and 25 g of acetone were magnetically stirred at a revolving speed of 900 r/min for 5 minutes, and then subjected to ultrasonic treatment for 30 minutes at a frequency of 40 kHz to obtain a 1,5-benzodifuranone pigment solution. Then, the obtained 1,5-benzodifuranone pigment solution and 31.1 g of epoxy resin 828 were magnetically stirred at 900 r/min for 10 minutes to obtain a mixed feed solution. Finally, the mixed feed solution and 42.2 g of polyamide curing agent 3388 were magnetically stirred at 900 r/min for 10 minutes, and then subjected to ultrasonic treatment for 5 minutes at 40 kHz to obtain the stimuli-responsive color-changing functional liquid coating.

### Application Example 1

A standard steel test plate was washed with acetone, n-hexane and deionized water in sequence and air-dried, obtaining the pretreated standard steel test plate. The stimuli-responsive color-changing functional coating obtained according to embodiment 1 was applied to the pretreated standard steel test plate by using a 120 m applicator, and the standard steel test plate covered with the stimuli-responsive color-changing functional coating was placed in an environment away from light at 20° C. for 7 days for curing, thereby obtaining a stimuli-responsive color-changing functional coating film.

### Application Example 2

A standard steel test plate was washed with acetone, n-hexane and deionized water in sequence and air-dried, obtaining the pretreated standard steel test plate. The stimuli-responsive color-changing functional coating obtained according to embodiment 2 was applied to the pretreated standard steel test plate by using a 120 m applicator, and the standard steel test plate covered with the stimuli-responsive color-changing functional coating was placed in an environment away from light at 20° C. for 7 days for curing, thereby obtaining a stimuli-responsive color-changing functional coating film.

The stimuli-responsive color-changing functional coating film obtained according to example 1 of application was tested by using the following testing methods under different stimulus conditions.

1. Method of determining coating film colors: the coating was scanned by using an ultraviolet-visible spectrophotometer in a reflectivity mode with a scanning wavelength of 400-700 nm, thereby obtaining an ultraviolet/visible spectrum of the coating. CIELAB values of the coating film were determined by using a whiteness color determinator, where L* represents a lightness index, a* and b* chroma indexes, a* red-green value, and b* yellow-blue value.

2. Coating film color images: the images were captured by using an optical microscope.

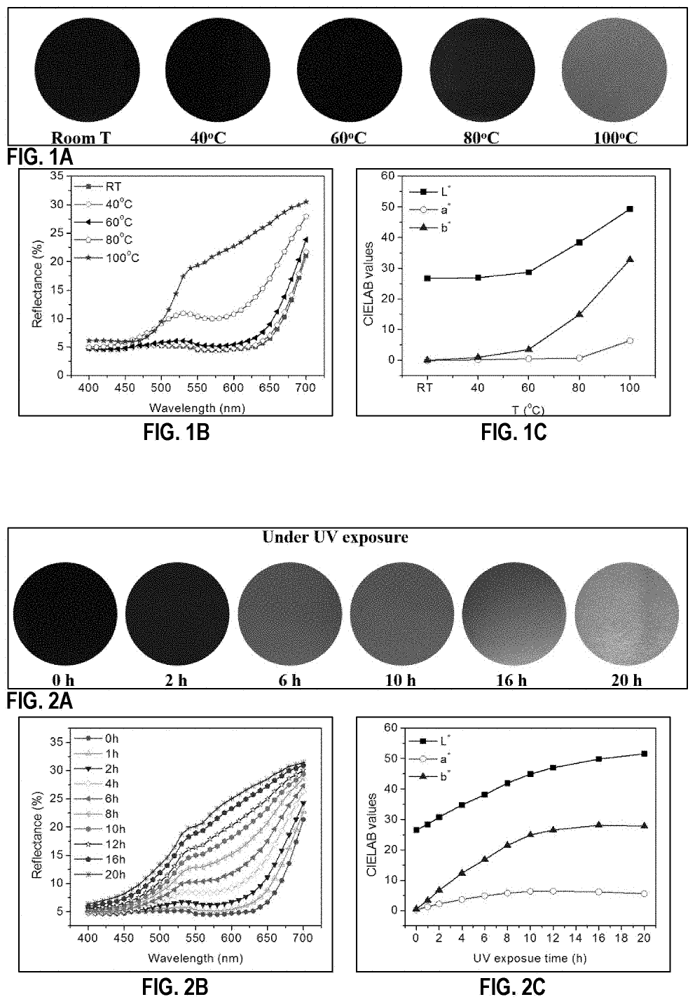

The following stimuli were applied to the stimuli-responsive color-changing functional coating film obtained according to example 1 of application: 1. Temperature stimulus: the stimuli-responsive color-changing functional coating film obtained according to example 1 of application was placed in a drying oven and heated at temperatures of 20° C., 40° C., 60° C., 80° C., and 100° C., for 2 hours. Then, the coating film before and after heating were tested on color and photographed by the above testing methods, with test results shown in FIGS. 1A-1C.

2. Ultraviolet stimulus: the stimuli-responsive color-changing functional coating film obtained according to example 1 of application was placed in an ultraviolet irradiation box with settings of ultraviolet wavelength 340 nm, temperature 45° C., irradiation intensity 0.68 W/m², and irradiation time 0 h, 2 h, 6 h, 10 h, 16 h, and 20 h. Then, the coating film before and after exposure to ultraviolet irradiation were tested on color and photographed by the above testing methods, with test results shown in FIGS. 2A-2C.

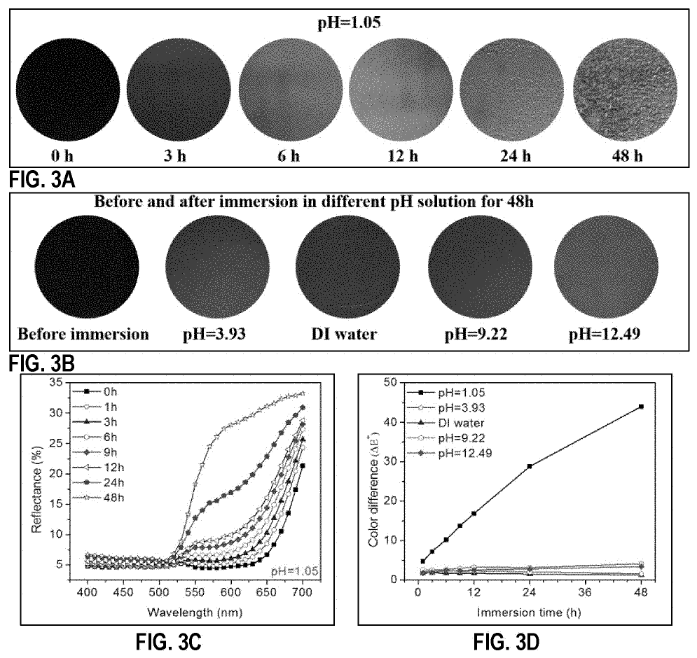

3. Strongly acidic environmental stimulus: the stimuli-responsive color-changing functional coating film obtained according to example 1 of application was immersed into solutions different in acidity and alkalinity (with pH as the criterion of measuring the acidity and alkalinity), where the pH values of the solutions were 1.05, 3.93, 7 (deionized water), 9.22, and 12.49; the temperature was 20° C., and the immersion time was 0 h, 1 h, 3 h, 6 h, 9 h, 12 h, 24 h, and 48 h, respectively. Then, the coating film before and after immersion into the solutions were tested on color and photographed by the above testing methods, with test results shown in FIGS. 3A-3D.

As can be seen from FIG. 1A, at the heating temperatures of 80° C. and 100° C., the color of the coating film changed obviously. With the temperature increasing, the color of the coating film changed from dark blue to brownish yellow. As can be seen from FIG. 2A, when the irradiation time was more than 6 h, the color of the coating film changed obviously. The color of the coating film changed from dark blue to brownish yellow over the time of irradiation. As can be seen from FIG. 3A, when the solution was strongly acidic (with a pH value of less than or equal to 1.05), the color of the coating film changed obviously. In a strongly acidic environment, the color of the coating film changed from dark blue to brownish yellow over the time of immersion. In addition, the color of the coating film under the neutrality condition was different from the color of the coating film under acidic/basic conditions. As can be seen from FIGS. 1A through 3D, when the furanone pigment was 1,5-benzodifuranone, the coating film had a color-changing characteristic at different stimuli.

The film formed by the stimuli-responsive color-changing functional coating in the present invention may have a thermochromic characteristic because it has different colors at different temperatures and may have an obvious color change with temperature, and thus can indicate a change in environmental temperature by a change in color. The stimuli-responsive color-changing functional coating in the present invention may have an ultraviolet-photochromic characteristic because it has an obvious color change with the time of irradiation when exposed to ultraviolet irradiation, and thus can indicate a change in environmental ultraviolet irradiation time by a change in color. The stimuli-responsive color-changing functional coating in the present invention may have an acidic-stimulus responsive color-changing characteristic because it has an obvious color change with the time of immersion in a strongly acidic condition and can indicate a change in environmental acidity by a change in color.

It needs to be noted that the stimuli-responsive color-changing functional coating in the present invention is subject to the type of content of the furanone pigment, the amine curing agent or the epoxy resin. In the present invention, the stimuli-responsive color-changing functional coating may have uncountable colors as well as uncountable color changes after being exerted with corresponding stimuli.

For example, when the furanone pigment is 1,8-benzodifuranone, the color of the stimuli-responsive color-changing functional coating in the present invention may change from greenish black to yellow with the temperature increasing in a temperature range of 80-120° C. (heating for more than 1.5 hours). When exposed to ultraviolet irradiation (340 nm, 45° C., an irradiation intensity of 0.68 W/m², and irradiation lasting for more than 4 hours), the color of the coating may change from greenish black to yellow over the time of irradiation. Under a strongly acidic condition (a pH value of less than or equal to 1.05, and immersion time of more than 3 hours), the color of the coating may change from greenish black to yellow over the time of immersion.

With the stimuli-responsive color-changing characteristic of the film formed by the stimuli-responsive color-changing functional coating in the present invention, the stimuli-responsive color-changing functional coating can be used in the response to environmental stimuli, in particular, for example, in a temperature-responsive, ultraviolet-responsive or strongly acidic condition-responsive smart sensor material, an anti-counterfeiting device or crop growth, and has extremely high application value and economic value.

Several examples are used for illustration of the principles and implementation methods of the present invention. The description of the embodiments is used to help illustrate the method and its core principles of the present invention. In addition, those skilled in the art can make various modifications in terms of specific embodiments and scope of application in accordance with the teachings of the present invention. In conclusion, the content of this specification shall not be construed as a limitation to the invention.

The embodiments described above are only descriptions of preferred embodiments of the present invention and are not intended to limit the scope of the present invention. Various variations and modifications can be made to the technical solution of the present invention by those of ordinary skill in the art, without departing from the design and spirit of the present invention. The variations and modifications should all fall within the claimed scope defined by the claims of the present invention.

What is claimed is:

1. A stimuli-responsive color-changing functional coating, comprising:
an epoxy resin,
a furanone pigment,
an amine curing agent, and
a solvent.

2. The stimuli-responsive color-changing functional coating of claim 1, wherein the furanone pigment is selected from: furofuran and benzodifuranone.

3. The stimuli-responsive color-changing functional coating of claim 2, wherein the furanone pigment is selected from one or more of: 1,8-benzodifuranone, 1,5-benzodifuranone, and furofuran.

4. The stimuli-responsive color-changing functional coating of claim 1, wherein the furanone pigment is selected from one or more of 1,8-benzodifuranone, 1,5-benzodifuranone, and furofuran.

5. The stimuli-responsive color-changing functional coating of claim 1, wherein the amine curing agent is selected from: a primary amine curing agent and a secondary amine curing agent; and wherein the solvent includes a non-activated thinner.

6. The stimuli-responsive color-changing functional coating of claim 5, wherein the non-activated thinner is selected from one or more of: acetone, toluene, xylene, and N,N-dimethylformamide.

7. The stimuli-responsive color-changing functional coating of claim 1, wherein an amount of the epoxy resin is based on a quantity of epoxy groups, and an amount of the amine curing agent is based on a quantity of amine hydrogen; a molar ratio of the epoxy resin to the amine curing agent is (0.5-2.0):1;
a mass of the furanone pigment is 1.5-2.5% of the total mass of the epoxy resin, the furanone pigment and the amine curing agent; and
a mass of the solvent is 15-30% of the total mass of the stimuli-responsive color-changing functional coating.

8. A method of preparing a stimuli-responsive color-changing functional coating, comprising the following steps:
(1) mixing a furanone pigment with a solvent, and then removing bubbles to obtain a furanone pigment solution;
(2) mixing the furanone pigment solution obtained in the step (1) with an epoxy resin to obtain a mixed feed solution; and
(3) mixing the mixed feed solution obtained in the step (2) with an amine curing agent, and then removing bubbles to obtain the stimuli-responsive color-changing functional coating.

9. An application of a stimuli-responsive color-changing functional coating, which is prepared from an epoxy resin, a furanone pigment, an amine curing agent, and a solvent, the application comprising:
applying the stimuli-responsive color-changing functional coating over a substrate, and
after the coating is cured, exerting an environmental stimulus thereto, allowing an environmental change to be reflected by a change in color,
wherein the environmental stimulus includes one of: a temperature, ultraviolet light, and a pH value.

10. The application of claim 9, wherein the application is in a smart sensor material, an anti-counterfeiting device or crop growth that is susceptible to a temperature, responsive to ultraviolet light or responsive to a strongly acidic condition.
